(19) United States
(12) Patent Application Publication
(10) Pub. No.: US 2009/0130248 A1
(43) Pub. Date: May 21, 2009

(54) Extended Energy Beverages

(75) Inventors: Laure Marie-Therese Jolly-Zarrouk, Paris (FR); Ann Monica Fischer, Savigny (CH); Sylvie Joelle Merinat, Mezieres (CH); Frederic Robin, Chailly/Lausanne (CH); Undine Lehmann, Lausanne (CH)

Correspondence Address: K&L Gates LLP, P.O. Box 1135, CHICAGO, IL, 60690, US

(73) Assignee: NESTEC S.A., Vevey (CH)

(21) Appl. No.: 11/911,078

(22) PCT Filed: Apr. 7, 2006
(86) PCT No.: PCT/EP2006/003178

§ 371 Date: Oct. 9, 2007

(30) Foreign Application Priority Data
Apr. 25, 2005 (EP) 05103342.1

(51) Int. Cl. A23L 2/52; A23G 1/56; A23L 2/02; A23L 2/38; A23C 9/154

(52) U.S. Cl. 426/2; 426/590; 426/593; 426/599; 426/598; 426/580

(57) ABSTRACT

A method of reducing the rate of digestibility of a beverage so as to increase the period of time over which the beverage supplies energy to an individual who has consumed it by supplementing the beverage with a heat moisture treated starch is disclosed. Ready-to-drink and reconstitutable extended energy beverages are also included.

This invention relates to the use of heat moisture treated starch to prepare extended energy beverages, preferably malted beverages.

Starches are polymers of glucose. The simplest type of starch is amylose which consists of a straight chain of glucose molecules with glycoside links between the first carbon atom of one glucose unit and the fourth carbon atom of the next. Another type of starch called amylopectin has a branched structure. Starches are the storage carbohydrates of plants and the relative amounts of amylose and amylopectin differ in starches from different sources as do the sizes of the starch molecules themselves. When starches are eaten, they are digested by the action of a group of enzymes called amylases which hydrolyse the starch. Uncooked starch is resistant to the action of the amylase enzymes but the process of cooking swells the starch granules resulting in a gel on which amylase can act. However, as cooked starch cools, a proportion undergoes crystallization to a form that is again resistant to amylase action.

Recent studies have shown that plasma glucose and insulin responses vary with the type and physical form of starch-containing foods ingested. It is believed that this effect is related to the differences in the rate of digestion of these different types and forms of starch containing foods. It follows that the use of foods containing different types of starch may be of interest in the control of diabetes and obesity by moderating the increase in blood glucose levels after eating. Further, such foods could have application in healthy persons interested in satiety management and they may also be of interest to individuals such as sportsmen requiring sources of sustained energy, particularly in foods which can easily be consumed “on the go” away from home.

It has already been proposed to exploit the relationship between structure and digestibility of starches with the object of producing modified starches that are digested more slowly than conventionally cooked starches. Such modified starches are known as slowly digestible starches or SDS. For example, US Patent Application 2003/0161861 describes solid cereal products such as biscuits or crackers having an SDS content relative to the total starch content higher than about 12 wt %, preferably higher than about 20 wt %. These cereal products are not, however, supplemented with a specially prepared SDS but rather the patent application relates to the use of food products which inherently contain the desired quantity of SDS. EP 1 362 517 describes a SDS produced by enzymatic debranching of low amylose starches. This SDS is stated to be suitable for use in beverages but unfortunately it has been found that it does not survive the heat treatments that are conventionally used in the preparation of both ready to drink beverages and beverage powders.

EP 388 319 and 465 363 describe SDS produced by reacting a farinaceous substance with a fatty acid compound such that enzymatic action is inhibited. The SDS thus produced are used to make noodles, bread, cakes and the like food products.

WO 03/105605 relates to the use of pullulan as an SDS. According to this document, pullulan is a water soluble, viscous polysaccharide consisting of units of three α-1,4 linked glucose molecules that are repeatedly polymerized by α-1,6 linkages on the terminal glucose molecule. Pullulan is elaborated extracellularly by a specific strain of black yeast, Aureobasiidium pullulans. Typical food starches such as corn starch contain a proportion of amylopectin which also has both α-1,4 and α-1,6 linkages. For pullulan, however, the α-1,6 linkages serve to extensively cross-link individual short chains. Leading to a specific structure which is not easily digested and which contributed to the previous reputation of pullulan as an indigestible polysaccharide.

However, to the Applicant's knowledge, no SDS based on widely available food grade materials have been specifically designed for use in beverage products having regard to the specific requirements of this type of product and a need thus exists for alternative types of SDS, particularly those stable to thermal processing.

U.S. Pat. No. 5,989,350 describes a heat moisture treated starch with a high degree of viscous stability suitable for use as a thickener or gelling agent. Other heat moisture treated starches are known for this purpose.

It has now surprisingly been found that, in addition to the properties that make them suitable for use as thickeners in processed foods, heat moisture treated starches also have a reduced rate of digestibility compared to untreated cooked starches and thus that they are suitable for use in applications where an SDS is required. However, heat moisture treated starches have the additional unexpected benefit when compared with other types of SDS such as those produced by enzymatic hydrolysis that they are stable to further thermal processing of the type typically used in the food industry such as pasteurization, sterilization and UHT treatments.

Accordingly, the present invention provides a method of reducing the rate of digestibility of a beverage so as to increase the period of time over which the beverage supplies energy to an individual who has consumed it by supplementing the beverage a heat moisture treated starch.

The invention also extends to the use of a heat moisture treated starch to reduce the rate of digestibility of a beverage so as to increase the period of time over which the beverage supplies energy to an individual who has consumed it.

The invention further extends to an extended energy beverage which is supplemented with heat moisture treated starch such that the beverage contains from 1.5 to 15 times as much slowly digestible starch as is conventionally found in an unsupplemented beverage of that type.

In this specification:—

The term “slowly digestible starch” or “SDS” is used to designate that starch which is digested between 20 minutes and 4 hours after ingestion according to the technique of Englyst et al (European Journal of Clinical Nutrition, 46: S33-S50 (1992)).

The term “extended-energy beverage,” designates a beverage that takes longer to digest than an isocaloric conventional beverage of the same type. For example, an extended-energy beverage including heat-moisture treated starches according to the invention should provide energy for at least about 10 percent, preferably at least about 25 percent, and more preferably at least about 50 percent, more time than the same quantity of a conventional beverage of the same type.

The beverage of the invention may be a juice beverage optionally containing fruit pulp, a dairy beverage based, for example, on yoghurt, a soy milk beverage, a malted beverage, a chocolate beverage, or a combination thereof.

Just as a beverage of the invention can provide extended-energy when compared with an isocaloric conventional beverage, equally it will be appreciated that a beverage of the invention may generate a feeling of satiety for the a similar period of time to a conventional beverage with a higher calorie content. Thus, the beverages of the invention can be employed to provide a method of reducing daily caloric intake.

It will be appreciated that the invention relates not only to ready-to-drink beverages but also to beverage powders which may be reconstituted by the addition of water, milk or other liquid to create an extended energy beverage which contains from 1.5 to 15 times as much slowly digestible starch as is conventionally found in an unsupplemented beverage of that type. The amount of liquid required to maintain the solids content (i.e. any insoluble ingredients in the beverage powder) dispersed throughout the beverage will vary depending on the exact nature of the heat-moisture treated starch component and the beverage component, as will be appreciated and readily determined by those of ordinary skill in the art. The amount of liquid will typically be at least about 40 weight percent to about 95 weight percent, preferably from about 50 weight percent to about 90 weight percent. Typically, 20 to 24 grams of the beverage powder will be mixed with 200 ml of water, creamer, milk, yoghurt, juice or the like.

Reconstitutable beverages of the invention have the added advantage that athletes and recreational sportsmen and women such as mountain climbers, skiers, fishermen, golfers, and the like, can more readily transport the reconstitutable beverage and add liquid at a remote location away from a typical eating area, e.g., water for example from a lake or river or other source of potable water such as a water fountain can be added to reconstitute the beverage on a mountain, ski slope, on a fishing boat or on a golf course.

It is also possible to use liquid concentrates for the reconstitutable beverages, which permit less water or other liquid beverage component to be added upon reconstitution while still facilitating proper dispersion of the solids into the liquid to form the beverage. When liquid concentrates are used as the reconstitutable beverage, it is typical that the water content is less than about 50 percent of the water present in a ready-to-drink beverage of the invention.

The extended energy beverage of the invention may contain from 5 to 20% (dry weight basis) of a heat-moisture treated starch. It will be appreciated that the heat moisture treated starch may replace some of the carbohydrate conventionally found in a beverage of the type concerned. For example, in a beverage powder such as the malted beverage sold under the trade mark MILO®, a portion of the carbohydrate usually used may be replaced by heat moisture treated starch. Alternatively, the heat moisture treated starch may simply be added to the beverage. For example, orange juice naturally has a low content of SDS and an extended energy orange juice drink may be provided by simply adding a suitable quantity of heat moisture treated starch to orange juice.

Thus, an extended energy beverage according to the invention may be prepared by adding an appropriate quantity of heat moisture treated starch to a beverage powder and then reconstituting the beverage in the usual way, or by adding the heat moisture treated starch to the beverage itself. In either case, the heat moisture treated starch may be a simple addition or it may be used to replace some of the starch that would be used to make a conventional beverage of the type in question.

Preferred types of starch for use in the present invention include potato, tapioca, maize (corn), rice, sorghum, waxy maize, waxy rice, or any combination thereof. The amylose content of the starch can be up to about 70% by weight, preferably from 0.1 to 30% by weight.

Preferably the starch is heat moisture treated by mixing the selected starch with sufficient water to provide the mixture with a water content of from 15 to 35% by weight, preferably from 20 to 35% by weight. Without being bound by theory, it is believed that the restriction of the water content facilitates treatment of the starch granules without destroying or irrevocably altering the starch granules in a manner that breaks down their structure. It is believed that, as a result, the starch retains its general structure but becomes more crystalline in nature and therefore more difficult to digest. The starch and water are typically treated at temperatures of from 95° C. to 130° C., preferably from 100° C. to 110° C., for a time of about 10 to 90 minutes, preferably about 20 to 60 minutes. Preferably, the heat-moisture treatment is accomplished in equipment capable of agitating the mixture, for example a VOMM Turbo-reactor (commercially available from VOMM Impianti e Processi of Milano, Italy). Additional and more detailed guidance on suitable methods of heat-moisture treatment, as well as the resultant heat-moisture treated starches, are described in U.S. Pat. No. 5,989,350, which is hereby incorporated herein by express reference.

### EXAMPLES

The following examples are not intended to limit the scope of the invention, but merely to illustrate representative possibilities concerning the present invention. Reference will be made to the drawings in which:—

FIG. 1 is a graph of the digestibility profile of various different starches; and

FIG. 2 shows the proportion of SDS in each of the starches tested as shown in FIG. 1

### Example 1

Heat-moisture treated (“HMT”) starches, were prepared according to the general principles disclosed in U.S. Pat. No. 5,989,350. Native potato starch was mixed with sufficient water to produce a mixture with a water content of 32%. 0.35% by weight of emulsifier was added and the mixture was heated to 105° C. under rotation at 400 rpm. The digestibility profiles of this HMT starch, commercially available maltodextrin (a rapidly digestible sugar) and a native potato starch were examined by using an in-vitro digestion method that is designed to mimic human gastro-intestinal digestion conditions according to Englyst et al. Briefly, 500 mg samples of each material were weighted in 50 ml centrifuge tubes. After an initial treatment with pepsin in hydrochloric acid at pH1, the samples were incubated with a mixture of enzymes (amylase, invertase and amyloglucosidase) under controlled conditions of pH, temperature, viscosity and mechanical mixing. Aliquots were taken at 20 minutes, 60 minutes, 120 minutes and 240 minutes after the start of the hydrolysis. The amount of glucose released was measured using a GOPOD kit from Megazyme (detection based on a calorimetric enzymatic reaction). The amount of starchy material and sucrose digested was calculated from the amount of glucose measured corrected by a factor of 0.9. The amount of SDS was calculated as follows. The amount of glucose digested after 20 minutes was subtracted from the amount digested after 60 minutes to give a value SDS1*. The amount of glucose released after 60 minutes was subtracted from the amount released after 240 minutes to give a value SDS2*. The total SDS is the sum of SDS1* and SDS2*. As may be seen from FIG. 1, the HMT starch had a significantly higher SDS content than the other two materials tested. As is more clearly apparent from FIG. 2, the HMT starch contained 32% SDS compared with 12% and 15% for maltodextrin and potato starch respectively.

### Examples 2 to 5 and Comparative Examples 2 to 5

Four conventional beverage products were obtained or prepared and tested to determine the level of slowly-digestible starches contained therein (Comparative Examples 2 to 5). The HMT starch of Example 1 was then added to each beverage, which significantly increased the amount of SDS within the products (Examples 2-5). The results are shown in Table I below.

| Example/ | | SDS (% wt | |
|---|---|---|---|
| Comp. | Product | of total | % Increase |
| Example | Formulation | carbohydrates | (%) |
| Comp. | MILO ® beverage | 7.1 | — |
| Ex. 2 | | | |
| Ex. 2 | MILO ® beverage + 20% | 13.1 | 85% |
| | heat-moisture treated starch | | |
| Comp. | NESQUICK ® beverage | 1.5 | — |
| Ex. 3 | | | |
| Ex. 3 | NESQUICK ® beverage + | 6.4 | 330% |
| | heat-moisture treated starch | | |
| Comp. | Orange Juice | 0.6 | — |
| Ex. 4 | | | |
| Ex. 4 | Orange juice + | 8 | 1230% |
| | heat-moisture treated starch | | |
| Comp. | MIGROS ® strawberry | 2.1 | — |
| Ex. 5 | yoghurt drink | | |
| Ex. 5 | MIGROS ® drink + | 19.2 | 810% |
| | heat-moisture treated starch | | |

1. A method of reducing the rate of digestibility of a beverage so as to increase the period of time over which the beverage supplies energy to an individual who has consumed it comprising the steps of using a heat moisture treated starch in the beverage.

2. The method of claim 1 wherein the beverage contains from 5 to 20% by weight of the dry components of heat moisture treated starch.

3. The method of claim 1, wherein the heat moisture treated starch is produced by mixing a starch and water in an amount to provide a mixture with a water content between 15 and 35%, and heat treating the mixture at a temperature between 95 and 130° C.

4. The method of claim 3 wherein the mixture is rotated at between 400 and 535 revolutions per minute during the heat treatment.

5. The method of claim 3 wherein the mixture further includes an emulsifier in an amount of from 0.2 to 1% of the dry weight of the starch.

6. An extended energy beverage which is supplemented with heat moisture treated starch such that the beverage contains from 1.5 to 15 times as much slowly digestible starch as is conventionally found in a typical unsupplemented beverage.

7. A beverage as claimed in claim 6 which is selected from the group consisting of a soy milk beverage, a malted beverage, a chocolate beverage, a fruit juice beverage, a dairy beverage or a mixture thereof.

8. A method of providing energy to an individual comprising the steps of providing to the individual a beverage that was produced using heat moisture treated starch to reduce the rate of digestibility of the beverage so as to increase the period of time over which the beverage supplies energy to an individual who consumes it.

9. An energy beverage that comprises from 5 to 20% by weight of dry components of a heat moisture treated starch.

10. The energy beverage of claim 9, wherein the mixture further includes an emulsifier in an amount of from 0.2 to 1% of the dry weight of the starch.

11. The method of claim 1, wherein the heat moisture treated starch is produced by mixing a starch and water in an amount to provide a mixture with a water content between 20% and 35% and heat treating the mixture at a temperature between 100° C. and 110° C.

12. The method of claim 11, wherein the mixture is rotated at between 400 and 535 revolutions per minute during the heat treatment.

13. A method of providing a beverage comprising the steps of using a heat moisture treated starch to produce the beverage.

14. The method of claim 13, wherein the beverage contains from 5 to 20% by weight of the dry components of heat moisture treated starch.

15. The method of claim 13, wherein the heat moisture treated starch is produced by mixing a starch and water in an amount to provide a mixture with a water content between 15 and 35%, and heat treating the mixture at a temperature between 95 and 130° C.

16. The method of claim 13, wherein the mixture is rotated at between 400 and 535 revolutions per minute during the heat treatment.

17. The method of claim 13, wherein the mixture further includes an emulsifier in an amount of from 0.2 to 1% of the dry weight of the starch.
